(19) United States
(12) Patent Application Publication
(10) Pub. No.: US 2023/0322142 A1
(43) Pub. Date: Oct. 12, 2023

(54) Bag Holder Card for Vehicles

(71) Applicant: Stephen Albert Healton, Moreno Valley, CA (US)

(72) Inventor: Stephen Albert Healton, Moreno Valley, CA (US)

(21) Appl. No.: 17/658,830

(22) Filed: Apr. 12, 2022

(51) Int. Cl. B60N 3/08; B65F 1/14; B60R 11/00

(52) U.S. Cl. CPC B60N 3/08; B65F 1/1415; B60R 2011/0063; B60R 2011/0059; B60R 2011/0003; B60R 11/00

(57) ABSTRACT

A Bag Holder Card for organizing and keeping clean transportation vehicles by inserting a card in between the seat and the center console that has a device that will hold trash receptacles, or other objects, also to contain items in a pouch such as writing tools. The Bag Holder Card generally includes A stable unsecured trash bag support comprising: a support member sufficiently slender so as to fit between a motor vehicle seat and the center console of said vehicle; a stabilizer piece attached to the top portion of said support member sufficient to prevent movement of the support member during traffic; a bag attachment member connected to the forward portion of the support member for the attachment of a trash bag or other item.

### CROSS REFERENCES

A provisional patent was filed Apr. 12, 2021 application No. 63/258,099

### BACKGROUND OF THE INVENTION

Example embodiments in general relate to waste cards and more specifically it relates to a Bag Holder Card for organizing and keeping clean transportation vehicles by inserting a card in between the seat and the center console that has a device that will hold trash receptacles, or other objects, also to contain items in a pouch such as writing tools.

### SUMMARY OF THE INVENTION

An example embodiment of the present invention is directed to a waste card which includes a stable unsecured trash bag support comprising:

a support member sufficiently slender so as to fit between a motor vehicle seat and the center console of said vehicle; a stabilizer piece attached to the top portion of said support member sufficient to prevent movement of the support member during traffic;

a bag attachment member connected to the forward portion of the support member for the attachment of a trash bag or other item.

There has thus been outlined, rather broadly, some of the features of the Bag Holder Card in order that the detailed description thereof may be better understood, and in order that the present contribution to the art may be better appreciated. There are additional features of the Bag Holder Card that will be described hereinafter and that will form the subject matter of the claims appended hereto. In this respect, before explaining at least one embodiment of the Bag Holder Card in detail, it is to be understood that the Bag Holder Card is not limited in its application to the details of construction or to the arrangements of the components set forth in the following description or illustrated in the drawings. The Bag Holder Card is capable of other embodiments and of being practiced and carried out in various ways. Also, it is to be understood that the phraseology and terminology employed herein are for the purpose of the description and should not be regarded as limiting.

One object is to provide a Bag Holder Card for organizing and keeping clean transportation vehicles by inserting a card in between the seat and the center console that has a device that will hold trash receptacles, or other objects, also to contain items in a pouch such as writing tools.

Another object is to provide a Bag Holder Card that holds a waste container to put trash, such as wrappers or cans in, to contain them. Most common waste container would be a bag.

Another object is to provide a Bag Holder Card that will have a pocket that can be hung on the card to hold writing utensils to make it easy to access for the driver.

Another object is to provide a Bag Holder Card that will have a folding flap on the top of the card to create a pocket to hold Miscellaneous items the driver uses such as small tools.

Another object is to provide a Bag Holder Card that that will have a long clip to the top of the card that has an area to put words and logos, such as sport teams.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1: FIG. 1 is an Overview of the present invention. The card and how it will slip in between a car seat and the center console.

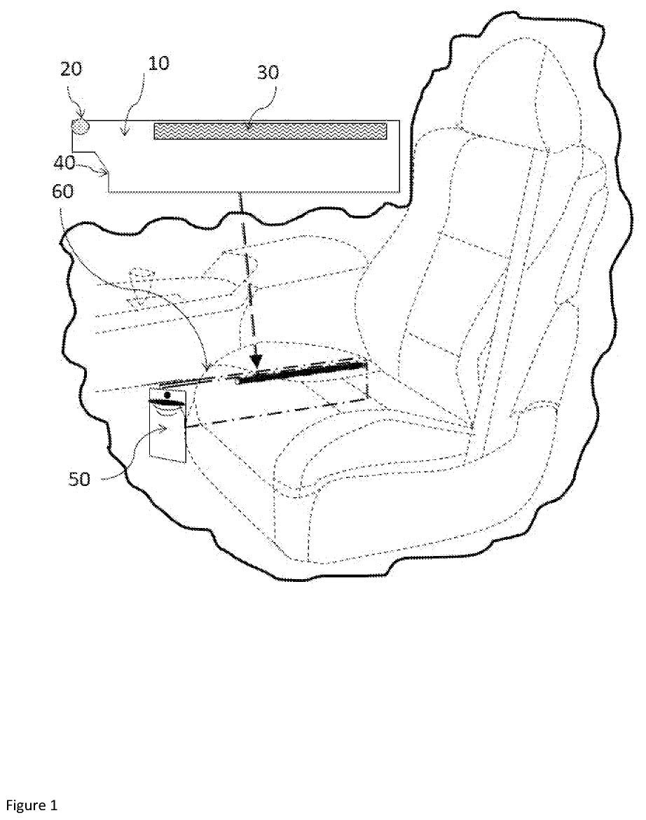

FIG. 2: FIG. 2 is a side view of the present invention, the card with several of the options.

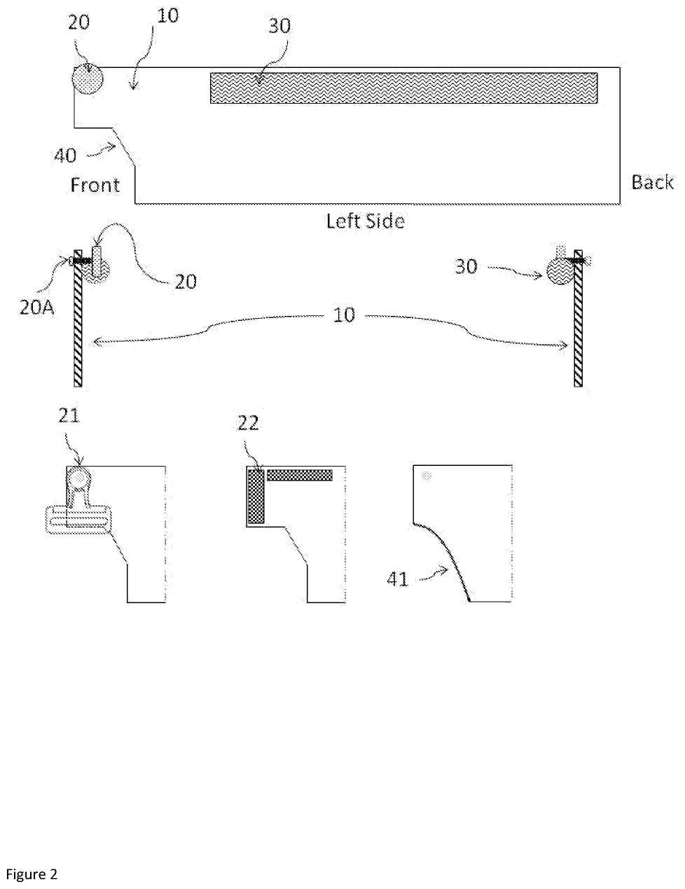

### DETAILED DESCRIPTION OF THE INVENTION

### A. Overview

Turning now descriptively to the drawings, in which similar reference characters denote similar elements throughout the several views, the figures illustrate an example embodiment comprising A stable unsecured trash bag support comprising:

a support member sufficiently slender so as to fit between a motor vehicle seat and the center console of said vehicle; a stabilizer piece attached to the top portion of said support member sufficient to prevent movement of the support member during traffic;

a bag attachment member connected to the forward portion of the support member for the attachment of a trash bag or other item's.

### B. Support Member

A stable unsecured “Card type” support that fits between a car seat and the center counsel. That will have a stabilizer piece and an item to attach bags, clipboards and other items to it.

The support member will be sufficiently slender so as to fit between a motor vehicle seat and the center console of said vehicle.

The support member can be a rectangle, or a rectangle with modified end(s), so that the end becomes not as tall as the highest point of the rectangle where item(s) can be attached to it, such as a knob, clip, hook, or a fastener, consisting of two strips of thin plastic sheet, one covered with tiny loops and the other with tiny flexible hooks. stripes. Depending on the vehicle interior design, it could also be a square, or square with a modified top to allow the attachment of a knob or clip.

### C. Stabilizer Piece

A stabilizer piece attached to the top portion of said support member sufficient to prevent movement of the support member during traffic.

The stabilizer, envisioned to be a soft material to compress between the support member and the seat in the vehicle, so that it will be able to stabilize the support member. It can be a wide range of material from insulation tubing to a pillow like material.

### D. Attachment Member

An attachment member connected to the forward portion of the support member for the attachment of trash bags, clipboard's or other items.

The member is connected to the forward portion of the support member for the attachment of a trash bag or other item.

The attachment member can be a knob, clip, hook or a fastener, consisting of two strips of thin plastic sheet, one covered with tiny loops and the other with tiny flexible hooks.

### E. Connections of Main Elements and Sub-Elements of Invention

The stabilizer piece attached to the top portion of said support member sufficient to prevent movement of the support member during traffic.

A bag attachment member connected to the forward portion of the support member for the attachment of a trash bag or other item.

On the double ended support member it would have an attachment on both the front and the back of the support member.

### F. Alternative Embodiments of Invention

A main variation would be a single attachment to hold a bag, to the double ended attachment, or one on the front and the back. This would be used for people in the front seat as well as the back seat to have a bag available to them.

The variations are many, from the type of material the support member is made of, from cardboard, foam core, plastic, metal or wood. The size varies for the types of cars it would need to fit.

Next the stabilizer piece attached to the side of the support member, again can be made of different material, but must be able to compress to be able to put pressure between the vehicle seat and center console.

The attachment member connected to the forward portion, can be a knob, clip, hook or a fastener, consisting of two strips of thin plastic sheet, one covered with tiny loops and the other with tiny flexible hooks..

### G. Operation of Preferred Embodiment

The “card” is pushed in between the seat and center console, so that one end will have the bag attachment stick out in such a way as being able to hang a trash bag for convenient use.

Then the driver of the vehicle, when having wrappers, used tissues, napkins, receipts, leftover from fruit, up to soda cans, can put the trash in the bag instead of on the seat, or floor of the vehicle.

When the bag is full, or needed to be changed, it is a simple matter of removing the bag and throwing it away, then replacing it with a new bag.

Therefore keeping the vehicle cleaner and less cluttered.

Other items can be hung from the attachment member such as a clipboard to keep track of mileage or deliveries.

Unless otherwise defined, all technical and scientific terms used herein have the same meaning as commonly understood by one of ordinary skill in the art to which this invention belongs. Although methods and materials similar to or equivalent to those described herein can be used in the practice or testing of the Supper Clean Card, suitable methods and materials are described above. All publications, patent applications, patents, and other references mentioned herein are incorporated by reference in their entirety to the extent allowed by applicable law and regulations. The Bag Holder Card may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A stable unsecured trash bag support to fit in a motor vehicle between the seat and the center console, said trash bag support comprising a support member (10); a stabilizer (30) attached to the top portion of said support member sufficient to prevent movement of the said support member during traffic; a bag attachment (20) connected to the forward portion of said support member for the attachment of a trash bag or other items; wherein said bag attachment allows a user to access items such as a bag or to be able to put items into the bag such as but not limited to trash.

2. The trash bag support (10) of claim 1, wherein said trash bag support is sufficiently flexible to adjust as necessary to fit between the motor vehicle seat and the center console of said vehicle and be able to adjust to different styles of seats.

3. The trash bag support of claim 1, wherein said stabilizer (30) is sufficiently able to compress to create tension between the vehicle seat and center console to sustain its place between the vehicle seat and center console.

4. The trash bag support of claim 1, wherein said bag attachment is a knob (20) allowing a bag to hang off said trash bag support and be added or removed.

5. The trash bag support of claim 1, wherein said bag attachment is a clip (21) connected to the forward portion of said support member that can be used for the attachment of a trash bag or other items, thus allowing a user convenient access to items such as but not limited to a set of papers.

6. The trash bag support of claim 1, wherein said bag attachment is a fastener (22), consisting of two strips of thin plastic sheet, one covered with tiny loops and the other with tiny flexible hooks, thus allowing for the attachment of a variety of different items such as specialized pockets to hold writing instrument or tools.
